(19) United States
(12) Patent Application Publication
(10) Pub. No.: US 2024/0243439 A1
(43) Pub. Date: Jul. 18, 2024

(54) COMPONENTS FOR BATTERIES

(71) Applicant: JAGUAR LAND ROVER LIMITED, Whitley, Coventry, Warwickshire (GB)

(72) Inventors: Wu MIAOLEI, Coventry, West Midlands (GB); Paul HANEY

(21) Appl. No.: 18/564,542

(22) PCT Filed: Mar. 3, 2022
(86) PCT No.: PCT/EP2022/055468

§ 371 Date: Nov. 27, 2023

(30) Foreign Application Priority Data
May 27, 2021 (GB) 2107575.9

(51) Int. Cl. H01M 50/505; B23K 26/22; H01M 50/526; H01M 50/571

(52) U.S. Cl. CPC H01M 50/505; B23K 26/22; H01M 50/526; H01M 50/571; H01M 2220/20

(57) ABSTRACT

Embodiments of the present invention provide components for batteries, and methods of manufacture of batteries or battery modules. In some embodiments, the methods comprise producing a plurality of sub-assemblies comprising a group of mechanically-connected cells (1000) and an associated busbar assembly (206), and subsequently assembling the sub-assemblies within a housing and electrically connecting the busbar assemblies (206) to produce a battery module.

### TECHNICAL FIELD

The present invention relates generally to components for batteries. In particular, but not exclusively, the invention relates to components for vehicle traction batteries. Aspects relate to a busbar assembly, to a battery module, to a battery pack, to a vehicle and to methods of laser welding a lattice portion of a busbar assembly, for example to form a busbar assembly, battery module, busbar assemblies, battery packs and vehicles.

### BACKGROUND

There has recently been increased interest in providing battery-powered vehicles, which has led to developments in vehicle batteries, in particular vehicle traction battery technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module as densely as can safely be achieved, so as to maximise the energy and current capacity that can be provided within a given packaging volume.

Electrical connections between cells are typically provided by a busbar assembly. It is generally desirable to reduce the size and weight of the busbar assembly, whilst also reducing the electrical resistance introduced by the busbar assembly.

It is also desirable to provide manufacturing processes that are highly repeatable and that avoid faulty electrical connections. A single battery module will typically comprise a large number of electrical connections between cells and the busbar assembly, and any faulty connections may lead to the entire module malfunctioning, potentially requiring an entire module failing quality control and having to be reworked where possible or otherwise scrapped.

It is an object of examples disclosed herein to at least mitigate one or more of the problems of the prior art.

### SUMMARY OF THE INVENTION

According to an aspect of the invention for which protection is sought, there is provided a busbar assembly comprising a terminal collection plate and a lattice portion electrically connected to the terminal collection plate,
wherein the sheet comprises a plurality of tabs arranged to protrude from the terminal collection plate, each tab being connectable to a terminal of an electrical cell, wherein the lattice portion comprises copper plated with a metallic layer, wherein the metallic layer comprises nickel and/or titanium. Advantageously, such a component is relatively light and low-cost. The metallic layer facilitates making of laser welded connections between copper and aluminium, and may also facilitate laser welding of the tabs to other metallic components, such as cell terminals. For example, the metallic layer may reduce reflectivity at infrared wavelengths, which may be particularly important in the event that the connections between the terminal collection plate and the lattice portion are made by an infrared laser welding system.

The metallic layer may also help to reduce oxidisation of the outer surfaces of the lattice portion, which improves weld quality and reduces the overall electrical resistance of the busbar assembly.

In an embodiment, the lattice portion is welded to the terminal collection plate. The lattice portion may be laser welded to the terminal collection plate, for example using an infrared laser welding system.

In an embodiment, at least part of the terminal collection plate extends in a first plane and the plurality of tabs are arranged to depend from the terminal collection plate at least partly in a direction normal to the first plane. Advantageously, the tabs depending in a direction normal to the first plane allows the tabs to be welded to cell terminals, without the rest of the busbar assembly coming into contact with the cell terminals.

In an embodiment, the lattice portion has a thickness of 0.2-0.4 mm preferably 0.3 mm.

In an embodiment, wherein the metallic layer has a thickness of 0.5-5 microns.

According to a further aspect of the invention for which protection is sought, there is provided a method of manufacture of a busbar assembly comprising:
providing a terminal collection plate and a lattice portion, wherein the lattice portion comprises copper plated with nickel and/or titanium;
positioning the lattice portion in contact with the terminal collection plate; and
welding the lattice portion to the terminal collection plate using a laser welding system.

According to a further aspect of the invention for which protection is sought, there is provided a battery module comprising a busbar assembly as described above.

According to a further aspect of the invention for which protection is sought, there is provided a battery pack comprising a busbar assembly or a battery module as described above.

According to a further aspect of the invention for which protection is sought, there is provided a vehicle comprising a busbar assembly, a battery module, or a battery pack as described above.

Within the scope of this application it is expressly intended that the various aspects, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Examples will now be described by way of example only, with reference to the accompanying figures, in which:

FIG. 1 shows a block of electrical cells bonded together according to examples disclosed herein;

FIGS. 2a, 2b and 2c show a block of electrical cells with each cell terminal welded to a respective terminal connection tab according to examples disclosed herein;

FIG. 3a shows an exploded view of a busbar assembly comprising a terminal collection plate and a lattice portion according to examples disclosed herein;

FIG. 3b shows a view of a busbar assembly comprising a terminal collection plate welded to a lattice portion according to examples disclosed herein;

FIG. 4 shows a flow chart illustrating a method of laser welding a lattice portion of a busbar assembly according to examples disclosed herein;

FIG. 5a-5c show weld point locations and weld ordering on the busbar assembly according to examples disclosed herein;

FIG. 6 shows a control system according to examples disclosed herein;

FIG. 7 shows a flow chart illustrating a method of manufacturing a battery module according to examples disclosed herein;

FIGS. 8a-8b illustrate views of a busbar assembly of FIG. 3b, indicating weld points of the terminal connection tabs to the respective electrical cell terminals, according to examples disclosed herein;

FIG. 9 shows a control system according to examples disclosed herein;

FIG. 10 shows a vehicle according to examples disclosed herein; and

FIG. 11 shows a flow chart illustrating a method of welding a busbar assembly to one or more cylindrical cells in another embodiment of the present invention.

### DETAILED DESCRIPTION

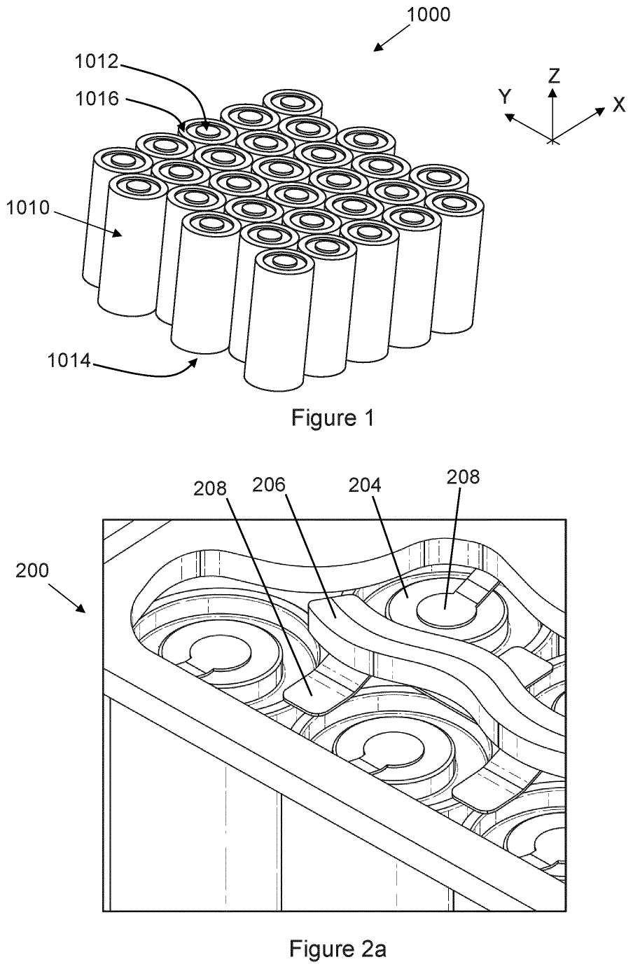

FIG. 1 shows a block 1000 comprising a plurality of cylindrical electrical cells 1010. The cells may be mechanically joined together, for example via an adhesive on the cylindrical surfaces of the cells 1010. The cylindrical electrical cells 1010 may be arranged in a side-to-side configuration. The block 1000 may comprise rows of cells 1010, with each row being offset from the adjacent rows by a distance approximately equal to the radius of one of the cylindrical electrical cells, thereby improving the efficiency with which the cells can be packaged into a given volume. It will be understood that other configurations of the block 1000 are also useful, and in some examples, the electrical cells need not be cylindrical.

The cylindrical electrical cells 1010 are widely available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used.

Each cell 1010 comprises a positive terminal and a negative terminal. The positive terminal may be provided by an end cap (e.g. a steel, or an aluminium, end cap) in a central region of the first end 1012 of the cell. The negative terminal in some examples may be provided by a steel cylindrical cap or plate at the second end 1014. The negative terminal in some examples may be provided by a steel cylindrical case which covers the second end 1014, the entire cylindrical surface between the first 1012 and second ends 1014, and a peripheral region 1016 of the first end surface 1012. The peripheral region 1016 of the first end surface 1012 may also be referred to as a “shoulder” region of the first end surface 1012. In commercially-available cells, it is sometimes the case that the end cap that defines the positive terminal on the first end surface 1012 protrudes beyond the shoulder region 1016 of the first end surface 1012, although this is not the case in the cells shown in FIG. 1.

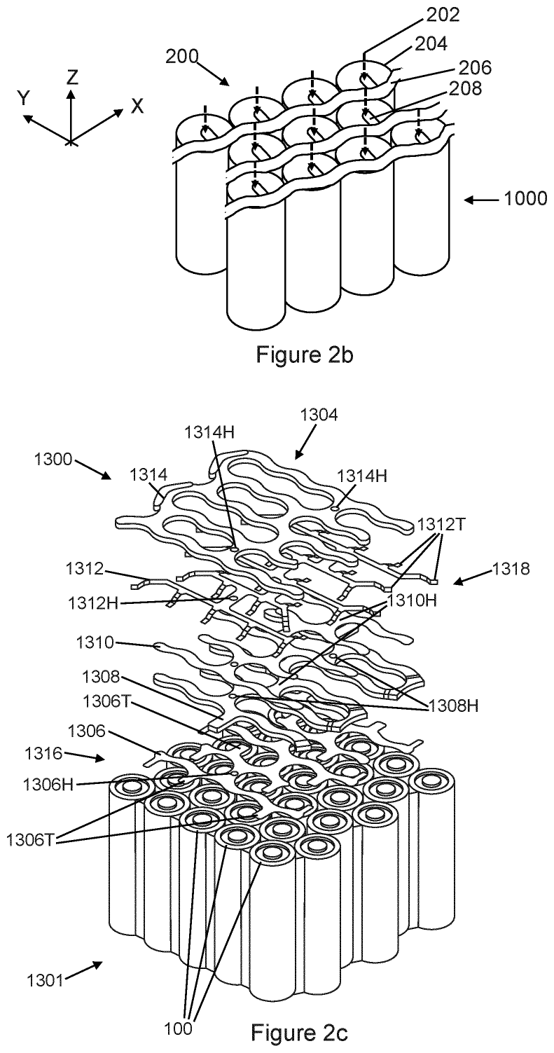

FIGS. 2a and 2b show a portion of an assembly 200 (which may be termed a battery module 200) comprising a block 1000 of electrical cells 1010 as shown in FIG. 1, with each cell terminal 204 welded to a respective terminal connection tab 208. The terminal connection tabs 208 are part of a single-sided busbar assembly 206 which is provided adjacent to the first ends 1012 of the cells 1010. The busbar assembly 206 is discussed below as comprising a lattice portion, and the terminal connection tabs 208 are part of the lattice portion. The lattice portion is welded to a terminal collection plate, as discussed below, to form the busbar assembly 206, the lattice portion thereby being electrically connected to the terminal collection plate. The lattice portion may comprise, or may be, copper. The terminal collection plate may comprise, or may be, aluminium. Thus, FIGS. 2a and 2b show a battery module 200 comprising a busbar assembly 206 as disclosed herein, and a plurality of electrical cells 1010 each having a first end surface 1012, wherein a first terminal 204 of each cell is located in a central region of the first end surface 1012. A plurality of terminal connection tabs 208 protruding from the lattice portion of the busbar assembly 206 are each welded to the central region of the first end surface 1012 of respective cells of the plurality of electrical cells 1010.

The busbar assembly 206 is configured to electrically connect to the terminals of a type (e.g. the positive terminals, or the negative terminals) of all of the cells. The busbar assembly 206 may, for example in an example connecting to the negative terminals of the cells, comprise a negative terminal collection plate (e.g. comprising aluminium) and connect to the negative terminals of the cells by a thin metallic sheet forming the lattice portion (e.g. comprising copper, for example copper plated with nickel). The thin metallic sheet is a conductive sheet and may be termed the ‘lattice portion’ of the busbar assembly. The busbar assembly 206 may, for example if connecting to the positive terminals of the cells, comprise a positive terminal collection plate (e.g. comprising aluminium) and connect to the positive terminals of the cells by a thin metallic sheet forming the lattice portion (e.g. comprising copper, for example copper plated with nickel).

In examples in which the positive terminals of the cells are located at one face of the assembly 200 and the negative terminals of the cells are located at an opposite face of the assembly 200, there may be two busbar assemblies 206—one to connect to the positive terminals and another to connect to the negative terminals. In examples in which the positive and the negative terminals of the cells are located at the same face of the assembly 200 (for example, the positive terminals are located in the centre of each of the cell ends, and the negative terminals are located at a shoulder region of the same cell ends), there may one busbar assembly 206 comprising both a positive terminal collection plate and a negative terminal collection plate, each having respective thin metal sheets (lattice portions) by which to connect to the corresponding terminals. In such a single busbar assembly 206 example, an insulating layer should be positioned between the negative terminal collection plate and corresponding thin metallic sheet, and the positive terminal collection plate and corresponding thin metallic sheet, to ensure that the positive and negative collection plates are electrically isolated from one another. That is, in some examples, the plurality of electrical cells 1010 of the battery module 200 may each have at least part of a second terminal located in a peripheral region 1016 of the first end surface 1012, and may have a second plurality of terminal connection tabs 208 protruding from a further lattice portion of the busbar assembly 206 which are each welded to the peripheral region 1016 of the first end surface 1012 of respective cells of the plurality of electrical cells 1010.

The busbar assembly 206 comprises a plurality of connection tabs 208 (e.g. formed from the thin metallic sheet) extending away from the body of the corresponding collection plate (that is, a plurality of positive terminal connection tabs (formed from the thin metallic sheet bonded to the positive collection plate) extend away from the body of the positive collection plate, and/or a plurality of negative terminal connection tabs (formed from the thin metallic sheet bonded to the negative collection plate) extend away from the body of the negative collection plate). The connection tabs 208 can be welded to the corresponding terminals of the cells in the group of cells 1010, and the positioning of the connection tabs is such that each cell 1010 can be connected to a respective connection tab 208 when the busbar assembly 206 is correctly positioned relative to the group of cells 1010.

The busbar assembly 206 may be positioned adjacent to the group of cells 1010 such that the positive and/or negative connection tabs 208 are in contact with the corresponding positive and/or negative terminals of the cells within the group of cells 1010. The connection tabs 208 are then electrically and mechanically connected to the respective terminals by laser welding. It will be understood that other methods of electrically and mechanically connecting the connection tabs to the terminals, including but not limited to other welding techniques, are also useful.

Each of the connection tabs 208 is positioned adjacent to a respective terminal of a single cell within the group of cells 1010, and a portion of the connection tab may be laser welded to the respective terminal. When laser welding the connection tabs 208 to the respective terminals, it is important to control the amount of energy used in the weld to ensure that the internal components of the cells are not damaged by the heat generated during the welding process. Accordingly, laser welding may be a particularly suitable technique, as it enables precise control of the amount of energy applied during each weld operation. Welding the plurality of terminal connection tabs 308 to respective electrical terminals 204 of a plurality of electrical cells 1010 may comprise controlling the laser welding system to control a laser beam generated by the laser welding system to produce a weld path comprising a predetermined shape, wherein the laser welding system is configured to control the beam to oscillate elliptically about the weld path.

Ensuring that the connection tabs 208 are in good electrical and mechanical contact with the respective terminals during welding the connection tabs to the respective terminals (and thus once welding has been performed) is important for the operation of the assembly 200.

The lattice portion and the and terminal collection plate of the busbar assembly 206 may be joined together by welding, e.g. laser welding, where the laser beam provides a concentrated heat source to fuse the parent materials of the lattice portion and the and terminal collection plate. Laser welding may desirably allow for narrow, deep welds to be formed with high production rates. An issue may arise when laser welding the assembly together due to localised heating at the weld point, which may cause distortion, which may be significant, of the busbar assembly. For example, it may be desirable to obtain a planar busbar assembly, and warping due to localised heating during welding the lattice portion to the terminal collection plate to form the busbar assembly may cause the busbar assembly to adopt a non-planar shape. A non-planar busbar assembly may make it more difficult to accurately and securely weld the terminal connection tabs of the busbar assembly to the cell array compared with a substantially planar busbar assembly.

FIG. 2c shows an exploded view of a sub-assembly 1300 for incorporation into a battery module including a plurality of tabs 1306T, 1312T which are to be welded to target locations on the respective electrical cells 1010, as will be described in more detail below.

The sub-assembly 1300 comprises a group of cells 1301, which are mechanically joined together using adhesive prior to connection of the busbar assembly. A single-sided busbar assembly 1304 is provided adjacent to the first ends of the cells within the group of cells 1301. The busbar assembly 1304 is arranged to electrically connect all of the cells within the group 1301 in parallel with one another. As will be discussed in more detail below, the single-sided busbar 1304 assembly is a busbar assembly in which the connections and terminal collection plates for the positive and negative terminals for a given group of cells 1301 are located at the same side of the group of cells. It will be understood that in alternative embodiments, separate busbar assemblies may be provided at the first end 1012 and the second end 1014 of the cells to connect to the positive and negative terminals of a group of cells, respectively.

The busbar assembly 1304 comprises a negative collection plate 1308 arranged to be electrically connected to the negative terminals of all of the electrical cells within the group of cells 1301. The connection between the negative collection plate 308 and the negative terminals of the cells is facilitated by thin metallic sheet 1306. The think metallic sheet is otherwise termed a lattice portion 1306. In the illustrated embodiment, the negative collection plate 1308 is formed from Aluminium and the lattice portion 1306 is formed from Copper plated with Nickel. In the illustrated embodiment, the copper sheet is 0.2-0.3 mm thick, and the thickness of the nickel coating is around 3 micrometers. It will be understood that other thicknesses of copper sheet and nickel coating are also useful, and that other materials are also useful for the sheet and coating.

The electrical and mechanical connections between the negative terminals, the lattice portion 1306 and the negative collection plate 1308 will be discussed in more detail below.

The busbar assembly 1304 further comprises a positive collection plate 1314 arranged to be electrically connected to the positive terminals of all of the cells within the group of cells 1301. The connections between the positive collection plate 1314 and the positive terminals of the cells is facilitated by a further thin metallic sheet 1312, or lattice portion. The lattice portion 1312 may be Copper plated with Nickel, wherein the Copper is 0.2-0.4 mm thick, preferably approximately 0.3 mm thick and the Nickel coating, or plating, is around 1-5 micrometres thick, preferably around 3 micrometres thick. An insulating layer 1310 is positioned between the negative collection plate 1308 and the thin lattice portion 1312, to ensure that the positive and negative collection plates are electrically isolated from one another.

Before the busbar assembly 1304 is connected to the group of cells 1301, each of the thin lattice portions 1306, 1312 are electrically and mechanically connected to the respective terminal collection plate 1308, 1314, by welding a portion of the lattice portion to the respective terminal collection plate. Although this can be achieved by any suitable welding method, laser welding through the thin metallic sheet of the lattice portion is particularly effective. The present inventors have recognised that the Nickel coating on the Copper sheet can help to facilitate laser welding of the sheet to both the collection plate and the cell terminals. Although the Copper sheet is coated with Nickel in the present embodiment, in alternative embodiments other coating materials, such as Titanium, may be used, or a mixture of Titanium and Nickel may be used.

Once the lattice portion 1306 is welded to the negative collection plate 1308, a negative busbar assembly 1316 is formed having a plurality of negative tabs 1306T extending away from the body of the negative collection plate 1308. In this way the plurality of tabs 1306T is arranged to protrude from the negative terminal collection plate 1308. As will be explained in more detail below, the negative tabs 1306T can be welded to the negative terminals of the cells in the group of cells 1301, and the positioning of the tabs is such that each cell 1010 can be connected to a respective tab 1306T when the negative busbar assembly 1316 is correctly positioned relative to the group of cells 1301. Similarly, when the thin lattice portion 1312 is welded to the positive collection plate 1314, a positive busbar assembly 1318 is formed. The positive busbar assembly comprises a plurality of positive tabs 1312T that can be welded to respective positive terminals of the cells in the group of cells 1301, and the positioning of the tabs is such that each cell 1010 can be connected to a respective tab 1312T when the positive busbar assembly 1318 is correctly positioned relative to the group of cells 1301. As can be seen from FIG. 2c, the negative tabs 1306T are coplanar with the rest of the lattice portion 1306, whereas the positive tabs 1312T extend outwardly and downwardly from the portions of the lattice portion 1312 that are welded to the positive collection plate 1314. This manner in which the positive tabs protrude from the positive terminal collection plate allows the positive tabs to pass through void spaces in the negative busbar assembly 1316 and the insulating layer 1310 and to connect to the positive terminals of the cells 1010, without contacting any part of the negative busbar assembly. It will be appreciated that the extent to which the tabs 1312T extend downwardly will depend, at least in part, on the shape of the cells used in the group, in particular, the extent to which the positive terminal formed in the end cap at the first end 1012 extends above, or is recessed below, the shoulder region 1016.

Once the positive and negative busbar assemblies 1316, 1318 are formed by welding the lattice portions to the respective terminal collection plates, the busbar assembly 1304 may be formed by mechanically joining the positive and negative busbar assemblies, with the insulating layer 1310 disposed between the two busbar assemblies. This may be achieved by passing electrically-insulating fixings through the aligned holes 1314H, 1312H, 1310H, 1308H, 1306H in the terminal collection plates, the lattice portions and the insulating layer. Additionally or alternatively, the insulating layer 1310 may have integrally formed fixings arranged to locate into and cooperate with through holes in the busbar assemblies, these fixings may then be heat staked or ultrasonically welded once the busbar assemblies have been correctly placed either side of the insulating layer. Additionally or alternatively, the two busbar assemblies may be secured to the insulating layer 1310 by a suitable electrically insulating adhesive or by an overmoulding process

In other embodiments the positive and negative collection plates comprise interleaved fingers which allow the components to be located in the same plane. Accordingly, it is not necessary for the tabs on one of the collection plates to extend towards the cells in a direction normal to the plane in which the busbar assemblies are located, and both sets of tabs may be provided on substantially planar lattice portions.

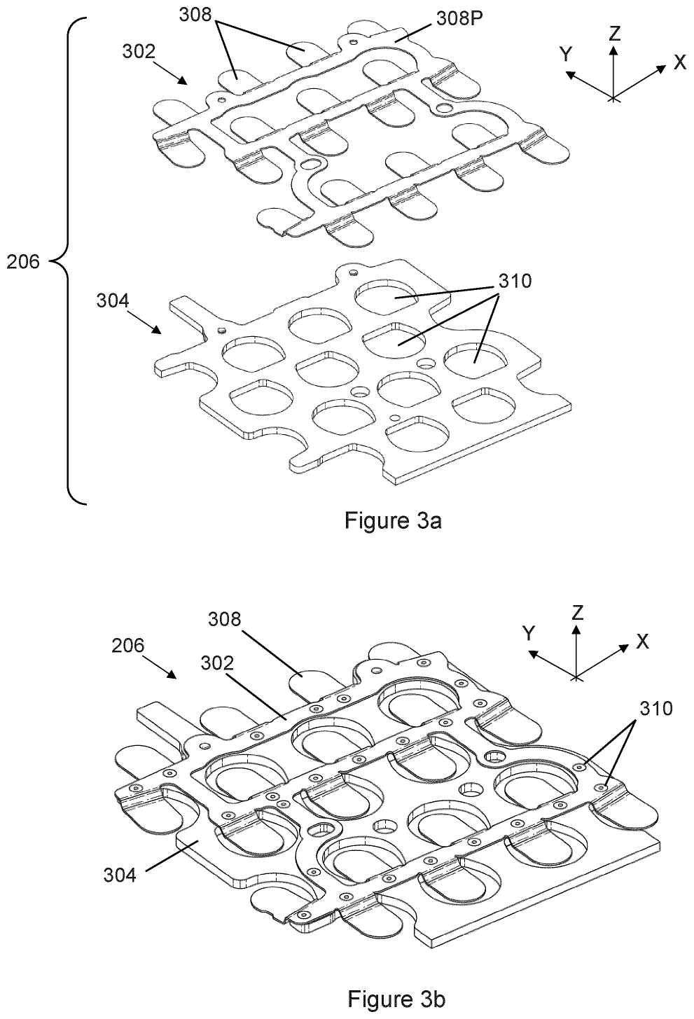

FIG. 3a shows an exploded view of a busbar assembly 206 comprising a terminal collection plate 304 and a lattice portion 302 prior to welding the two together. FIG. 3b shows a view of a busbar assembly 306 comprising a terminal collection plate 304 welded to a lattice portion 302 at a plurality of busbar weld locations 310. These views represent an example of a realistic form of busbar assembly. The order of making the busbar weld locations 310 to join the terminal collection plate 304 to the lattice portion 302 may be made in a way which may reduce the distortions which arise due to localised heating of the busbar assembly 306 caused by (laser) welding.

The lattice portion 302 comprises copper plated with a metallic layer, which is nickel in the illustrated embodiment. However, in other embodiments different metals may be employed, such as titanium, or a combination of metals such as nickel and titanium. The lattice portion 302 comprises a plurality of tab portions 308, each of which is configured to be welded to a terminal of a respective cell. In this way each tab is connectable to a terminal of a respective electrical cell. In the illustrated embodiment, the lattice portion comprises copper having a thickness of approximately 0.3 mm, plated with nickel having a thickness of approximately 3 microns. However, it will be understood that other thicknesses are also useful. For example, the copper sheet may have a thickness of 0.2-0.4 mm, and the metallic layer may have a thickness of 0.5-5 microns.

Advantageously, the metal layer may help to prevent oxidisation of the copper in the lattice portion 302. Furthermore, in some embodiments, the lattice portion may be connected to the collection plate 304 by laser welding, and in such embodiments the metallic layer may help to improve absorption of the laser energy at the wavelengths used by a laser welding system.

FIG. 3B shows the busbar assembly 206 in assembled form. As can be best seen in FIG. 3B, the collection plate 304 is substantially planar. However, the lattice portion 302 has a planar portion 308P which is attached to a face of the collection plate, and a plurality of tabs 308, which depend from the planar portion 308P and extend in a direction normal to the plane of the collection plate and the planar portion of the lattice portion. Several of the tabs 308 protrude through apertures 310 in the collection plate, and others extend beyond the collection plate. The tabs 308 allow the busbar assembly 206 to be electrically connected to the terminals of a plurality of cells 1010, without the risk of electrical connections taking place between the cells and any other part of the busbar assembly 206. This is particularly important when the busbar assembly 206 is used to make parallel connections between the positive terminals of a plurality of cells 1010 as shown in FIG. 1. When connecting positive terminals in parallel, it is essential to avoid any connections to the negative terminals (for example the shoulder region 1016).

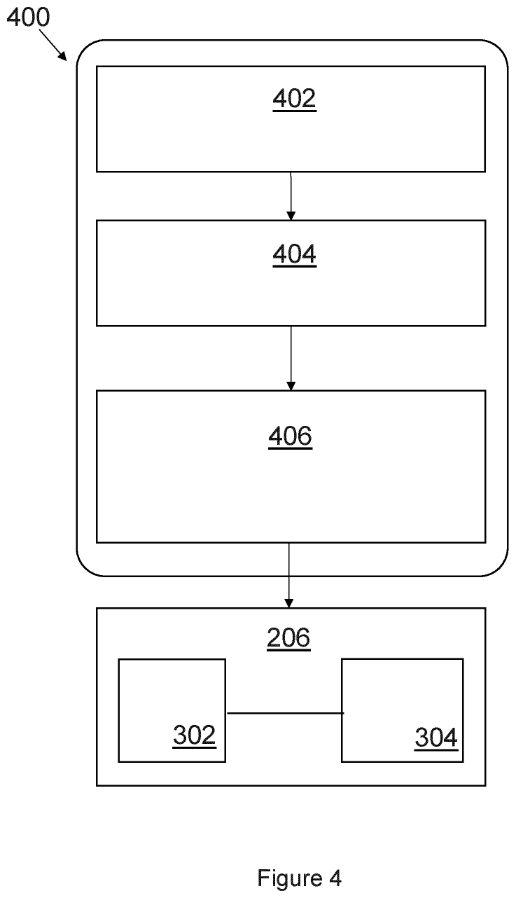

FIG. 4 shows a flow chart illustrating a method of laser welding 400 a lattice portion of a busbar assembly 206, which may address the issue of busbar assembly distortions arising due to heating effects arising during welding. In some examples, the lattice portion may comprise copper, and is welded to a terminal collection plate of the busbar assembly. The terminal collection plate may comprise aluminium in some examples.

The method 400 comprising controlling a laser welding system to perform a welding process to weld the lattice portion 302 and the terminal collection plate 304 together at a plurality of weld points by: welding the lattice portion and the terminal collection plate together at a first weld point 402; welding the lattice portion and the terminal collection plate together at a second weld point 404; and welding the lattice portion and the terminal collection plate together at a third point in a region formed between the first and the second weld point 406.

Between the first weld point and a subsequent weld point, the busbar assembly 206, at the subsequent weld point may be at a lower temperature than the busbar at the first position, due to the welding of the first point causing localised heating of the busbar assembly 206 at the first position. Welding the lattice portion 302 and the terminal collection plate 304 together at a first weld point 402 may cause a temperature gradient having a localised high temperature region at the first weld point and a low temperature region elsewhere. A subsequent weld point may then be located at a low temperature region of the weld surface, which is spatially distanced from the localised high temperature region, to reduce any further localised heating effect, and thereby, reduce any spatial distortion of the busbar assembly 206 due to localised heating.

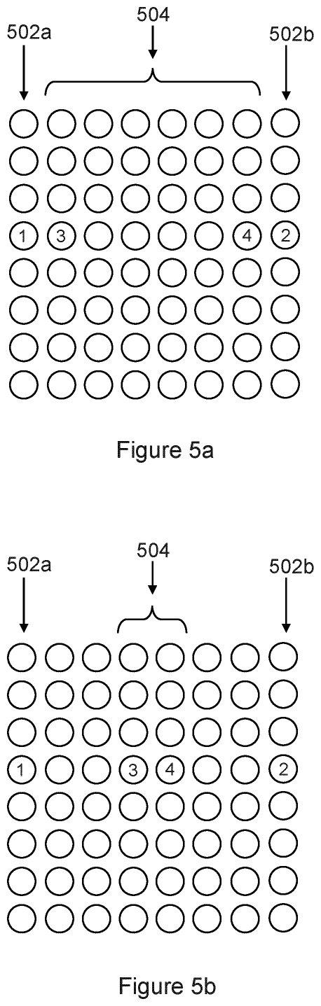

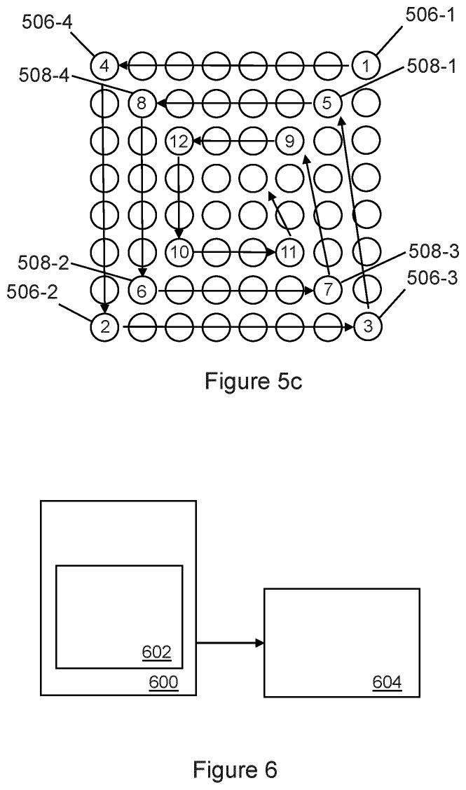

FIG. 5a-5c show schematically a series of example weld point locations 500 and weld ordering on the busbar assembly. Each weld point location 500 is illustrated by a circle in a square grid in these examples, but it will be appreciated that this square weld point location layout is shown for simplicity, and a real-world weld point location grid/arrangement may be more like the busbar weld points 310 locations shown in FIG. 3b. Furthermore, the examples of FIGS. 5a and 5b show weld points along a straight one dimensional line, whereas in a real world example, a distribution of weld points over a two dimensional plane may be made (as shown in FIG. 5c).

In these examples, the first weld point (labelled “1”) and the second weld point (labelled “2”) are in a peripheral region 502a, 502b of the busbar assembly, and the third weld point (labelled “3”) is in a central region 504 of the busbar assembly. The peripheral region 502a, 502b may be, for example, an outermost row of welds (that is, located proximal to the edge of the busbar assembly) as illustrated in FIGS. 5a-5c, a plurality of outermost rows of welds, or a percentage (or other proportional measure) of the total area located at the periphery of the busbar assembly.

In FIG. 5a, a first weld point “1” is located on a left edge 502a of the busbar assembly. The second weld point “2” is located on the opposite, right, edge 502b of the busbar assembly. By locating these first two weld points at opposite edges of the busbar assembly, the method of laser welding may be performed without using an external clamping member to forcibly clamp the lattice portion to the terminal collection plate during welding. This is because the first and second weld points “1” and “2” may each form clamping points, acting to clamp (or fix) the lattice portion to the terminal collection plate at the respective weld points—in this example, at the opposite outer edges. In this way, subsequent welds may be made between these two initial weld points and the lattice portion and terminal collection plate are fixed in place relative to each other by the initial welds to aid in accurate welding. Other example initial welding positions (e.g. diametrically opposite corners) may also allow the busbar assembly components to be welded together without requiring an external clamping member. It may be desirable in some examples to be able to perform welding without an external clamping member, which may in some circumstances exert forces which undesirably contribute to distortion of the busbar assembly. In some examples, due to the initial welds acting to hold the busbar assemblies together in place, a clamping member may still be used but with a lower clamping force applied than in examples where the clamping member is predominantly relied on for retaining the busbar assembly components in place during welding.

A plurality of weld points may be located between the first and second weld points, as also shown in FIGS. 5a-5c. The plurality of weld points (e.g. points “3” and “4”) located between the first and second weld points (e.g. points “1” and “2”) may be neighbouring each other in some examples, as in FIG. 5b.

In FIG. 5a, after the initial two weld points are made, at a left edge then a right edge, the third weld may be made away from the second weld, in this example, at the next weld point row inside from the left edge 502a where the first weld was made. In this way, localised heating caused by the first weld at location “1” has had time to cool while the second weld at location “2” is formed at the opposite edge 502b, and while the second weld is cooling, the subsequent third weld “3” is again made away from the most recent second weld to reduce further contributions to local heating at location “2”. The weld pattern may continue in this way moving back and forth over the busbar assembly, gradually moving towards the centre of the busbar assembly. As subsequent welds are closer together, the separation of successive weld points may decrease and as such the effect of reducing contributions to localised heating may also decrease. However, since these welds are made following previous welds outside these welds, the previous welds act to pin the busbar assembly into position, and the more welds are made (and thus the closer subsequent weld points become), the more weld points are already formed to pin the busbar assembly into position. Thus this ordering of weld points may be considered to be advantageous, as the mitigating effects of spatially separating subsequent weld points decreases as the number of existing weld points acting to stabilise the shape of the busbar assembly increase.

In FIG. 5b, after the initial two weld points “1” and “2” are made at peripheral locations 502a and 502b respectively, as in FIG. 5a (i.e. at a left edge then a right edge), the third weld may be made away from the second weld, in this example, at central weld point approximately equidistant from the first two weld points in the centre 504 of the busbar assembly. In this example, two further central weld points “3” and “4” are illustrated, wherein point “3” is located closer to point “1” and point “4” is located closer to point “2”, wherein both points “3” and “4” are substantially centrally located in the busbar assembly. In this way, localised heating caused by the first weld at location “1” has had time to cool while the second weld at location “2” was formed, and while the second weld is cooling, the subsequent third welds “3” and “4” are made away from the welds already formed, at the first and second weld points “1” and “2”. This may act to reduce further contributions to local heating at locations “1” and “2”, and since welds at points “1” and “2” are made to pin the edges of the lattice portion 302 to the terminal collection plate of the busbar assembly in place, distortions to the busbar assembly due to localised heating may be mitigated against since the edges are already locked into place.

Thus in these examples of FIGS. 5a-5c, the first weld point may be located at a first edge region 502a of the busbar assembly, and the second weld point may be located in a second edge region 502b of the busbar assembly, opposite the first edge region 502a. Further, these examples illustrate welding the lattice portion 302 and the terminal collection plate 304 together at a plurality of weld points of a peripheral region 502a, 502b of the busbar assembly; and welding the lattice portion 302 and the terminal collection plate 304 together at a plurality of weld points of an inner region 504, within the peripheral region 502a, 502b, of the busbar assembly.

As shown in FIG. 5c, the busbar assembly may comprise a plurality of corners 506-1 to 506-4, and the method of laser welding may comprise welding the lattice portion 302 to the terminal collection plate 304 together by welding the lattice portion 302 and the terminal collection plate 304 together at weld points located at each of the plurality of corners of the weld surface 506-1 to 506-4. The method of laser welding may comprise, after welding the lattice portion 302 and the terminal collection plate 304 together at the weld points located at each of the plurality of corners of the weld surface 506-1 to 506-4, welding the lattice portion 302 and the terminal collection plate 304 together at a plurality of inner weld points 508-1 to 508-4 of an inner region of the busbar assembly.

The method of laser welding may comprise welding the lattice portion 302 and the terminal collection plate 304 together at a plurality of weld points located along a weld path which spirals towards the centre of the busbar assembly. This is illustrated schematically in FIG. 5c. FIG. 5c shows a first peripheral series of weld points 506-1 to 506-4 are made at the top right (506-1), bottom left (506-2), bottom right (506-3) and top left (506-4). Thus, in this example, the first welds are made at the corners of the busbar assembly by welding opposite corner pairs. Following this, a second series of weld points are made within the first series of weld points, also in this example by welding at opposite corner pairs at the top right (508-1), bottom left (508-2), bottom right (508-3) and top left (508-4). By continuing in this way a series of loops are formed which may be said to spiral towards the centre of the busbar assembly from the periphery. Of course in other examples, other welding patterns may also be made which form a spiral towards the centre of the busbar assembly, such as welding, for example, in the order: top right (506-1), top left (506-4), bottom left (506-2), then bottom right (506-3) in a series of concentric-type loops.

A further example is of first welding in a clockwise loop, followed by welding in a counter-clockwise loop within the first loop, and continuing to alternate rotation direction while welding loops moving towards the centre of the busbar assembly. In this way the welding path may spiral towards the centre from the outer edge of the busbar assembly 206, on an alternating clockwise-anticlockwise path. In other words, welding the lattice portion 302 and the terminal collection plate 304 together at a plurality of inner weld points 508-1 to 508-4 of an inner region of the busbar assembly 206 may comprise welding a plurality of weld points 508-1 to 508-4 along a first weld point path in a first direction, the first weld point path located inside a peripheral region 502a, 502b of the busbar assembly 206; and welding at least one further plurality of weld points along at least one further weld point path in a second direction opposite the first direction, wherein the further weld point path is located within the first weld point path. As another example, the welding path may take a raster scan path back and forth along an edge, then an opposite edge, then back along the interior of the first edge, then back along the interior of the opposite edge. Other possible welding patterns may also be envisaged, which allow for a reduced localised heating effect by separating successive weld spots from each other, which allow for the lattice portion and the terminal collection plate 304 to be fixed together at peripheral points in the initial series of welds which may help reduce distortions due to heating from the welding process, and which are possible using a straightforward control system to move the weld points around on the busbar assembly in a well-controlled and accurate way

The lattice portion 302 and the terminal collection plate 304 may, in some examples, be each substantially flat in a rectangular plane, having a width of between 80 mm and 95 mm, and having a length of between 80 mm and 95 mm. The lattice portion may have different dimensions than the terminal collection plate 304, and/or one or more of the lattice portion and the terminal collection plate may be square. For example, the lattice portion may have dimensions 88 mm×89 mm, and the collection plate may have dimensions 85 mm×85 mm. In other examples the lattice portion 302 and the terminal collection plate 304 may have substantially the same dimensions. After welding according to examples disclosed herein, acting to reduce distortions in the busbar assembly by mitigating against local heating effects due to welding, the busbar assembly 206 may be distorted out of the flat plane of less than 0.2 mm.

FIG. 6 shows a control system 600 comprising one or more controllers 602. The control system 600 is configured to control a laser welding system 604 to perform a welding process to laser weld a lattice portion 302 of a busbar assembly 206 (which may comprise copper in some examples), to a terminal collection plate 304 of the busbar assembly 206 (which may comprise aluminium in some examples), at a plurality of weld points located on a weld surface. The control system 600 is configured to do so as discussed above, by: welding the lattice portion 302 and the terminal collection plate 304 together at a first weld point; welding the lattice portion 302 and the terminal collection plate 304 together at a second weld point; and welding the lattice portion 302 and the terminal collection plate 304 together at a third point in a region formed between the first and the second weld point.

The controller(s) 602 may each comprise a control unit or computational device having one or more electronic processors. A single control system 600 or electronic controller 600 may be used, or alternatively, different functions of the control system 600 may be embodied in, or hosted in, different controllers 602. A set of computer-readable instructions may be provided which, when executed, cause said controller(s) 602 or control module 600 to implement the methods described herein. The set of instructions may be embedded in one or more electronic processors, or alternatively, the set of instructions could be provided as software to be executed by one or more electronic processor(s). For example, a first controller 602 may be implemented in software run on one or more electronic processors, and one or more other controllers may also be implemented in software run on one or more electronic processors, or, optionally, on the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette);

optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

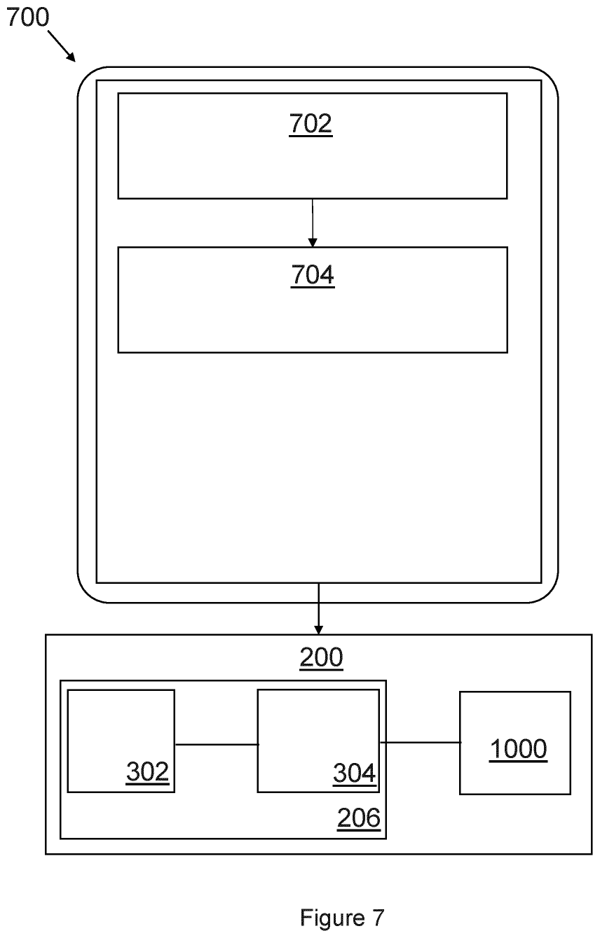

FIG. 7 shows a flow chart illustrating a method of manufacturing a battery module 300. The battery module 300 comprises a plurality of electrical cells 1010 and a busbar assembly 206. The busbar assembly 206 comprises a terminal collection plate 304 and a lattice portion 302. The lattice portion 302 comprises a plurality of terminal connection tabs 308. The terminal collection plate 304 may comprise aluminium. The lattice portion 802 may comprise copper. The lattice portion may comprise metal (e.g. nickel) passivated copper.

The method 700 comprises controlling a welding system to perform a welding process to: weld 702 the terminal collection plate 304 to the lattice portion 302 at a plurality of busbar welds 310 to form the busbar assembly 206; and weld 704 the plurality of terminal connection tabs 308 to respective electrical terminals of the plurality of electrical cells 1010. Each terminal connection tab 308 is welded to each respective electrical terminal by a terminal weld. A first distance is a distance along an electrical path on the lattice portion 302 between one of the plurality of terminal welds and the closest of one of the plurality of busbar welds 310. The first distance for each terminal weld is substantially electrically equivalent.

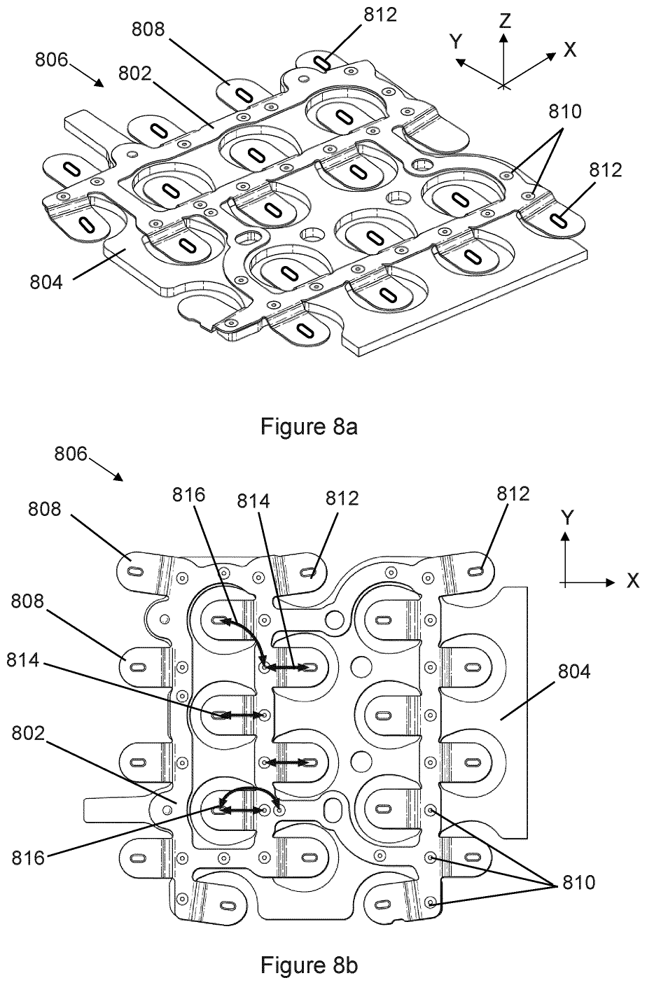

FIGS. 8a-8b illustrate views of a busbar assembly 806 as in FIG. 3b, indicating busbar weld points 810 and weld points 812 of the terminal connection tabs 808 to the respective electrical cell terminals. Similar elements to those in FIG. 3b are indicated with similar reference numerals. While the electrical cells are not illustrated here, the terminal welds 218 by which each terminal connection tab 808 would be welded to an electrical cell terminal in a battery module are shown. It can be seen that each terminal connection tab 808 would be welded to a respective electrical terminal by a terminal weld 812. The lattice portion 802 may have a width of between 60 mm and 120 mm; preferably between 80 mm and 90 mm. The lattice portion 802 may have a length of between 60 mm and 120 mm; preferably between 80 mm and 90 mm. The terminal collection plate 804 may have a width of between 60 mm and 120 mm; preferably between 80 mm and 90 mm. The terminal collection plate 804 may have a length of between 60 mm and 120 mm; preferably between 80 mm and 90 mm.

The first distance 814 along an electrical path on the lattice portion 802 between one of the plurality of terminal welds 812 and the closest of one of the plurality of busbar welds 810 may be seen in FIG. 8b, and this first distance 814, for each terminal weld 812 (i.e., for each terminal connection tab 808), is substantially electrically equivalent. In the example of FIGS. 8a and 8b, the first linear distance 814 is substantially the same distance (e.g. 5 mm+a tolerance error) for all the terminal welds 812 (it can be seen that each busbar weld 810 which acts as a weld point closest to a terminal weld 812 is located along a finger portion of the lattice portion 802 from which the terminal connection tabs 808 extend approximately perpendicularly, and that each terminal weld 812 is closest to a busbar weld 810 which is substantially centrally positioned with respect to the portion of the lattice portion 802 connecting the terminal connection tab 808 with the terminal weld 812). That is, each terminal connection tab 808 in some examples may have substantially the same cross sectional area, and thereby a resistance of each electrical path (terminal weld 812—closest busbar weld 810 path length) in the battery module may be substantially the same.

In other examples, the first distance 814 between a terminal weld and the closest busbar weld may differ in distance for different terminal welds (that is, the first distance 814 for each terminal weld 812 may a distance between, for example, 3 mm±a tolerance error and 7 mm±a tolerance error), but the distance still provides electrical equivalence for all the terminal welds 812. By electrical equivalency, it may be taken to mean that the electrical resistance of the path between the terminal weld 812 and the closest of the busbar welds 810 having a distance equal to the first distance 814 (i.e. separated by the first distance 814) is the same for all terminal weld-closest busbar weld pairs. Electrical equivalence may be understood to mean a particular electrical property (e.g. resistance) having the same value for each first distance 814, even if each first distance 814 is different in linear dimension. It may be the case, for example, that a first terminal weld 812—busbar weld 810 pair have a linear separation of 5 mm, and that a second terminal weld 812—busbar weld 810 pair have a linear separation of 4 mm, but because the lattice portion material between the second terminal weld 812-busbar weld 810 pair is thicker (has a larger cross sectional area) than the first terminal weld 812—busbar weld 810 pair, both the first and second weld pairs have the same first distance 814 since they each have electrically equivalent paths (e.g. the same resistance) between their two weld points 810, 812.

Equal resistances for all cells 1010 in the array 1000 are desirable because the cells are then used in a ‘balanced’ way, i.e., if one cell route (from cell—terminal connection tab—lattice portion—terminal collection plate) has a lower resistance (e.g. a shorter length L) than for other cells, than that cell may have more current drawn from it during its lifetime and may age more quickly. This means the whole cell array (battery module) is less balanced over time than if all cells had an equal current drawn from them, and the capacity of the whole unbalanced module/pack may be reduced by the single aged cell compared with a balanced battery module. If all electrical cells in the module/pack are kept balanced, then all cells age at the same rate and the pack capacity is improved compared to an unbalanced battery pack.

The cross sectional area (CSA) may be taken through the sheet of material forming the terminal connection tab 808 (i.e. for a flat/planar tab, the cross section may be taken substantially perpendicular to the plane of the tab 808). The resistance R of the electrical path may be taken to be proportional to the resistivity Ro×distance (path length) L×cross-sectional area of the tab CSA. The first distance 814 (path length) L may be taken to be from the centre of the weld connecting the electrical cell terminal to the terminal connection (the terminal weld 812), to the centre of the nearest weld connecting the lattice portion to the terminal collection plate (the busbar weld 810).

In considering the electrical equivalence of paths between proximal terminal welds 812 and busbar welds 810, other path lengths such as those of next nearest busbar welds 812, as indicated in FIG. 8b by the open arrows 816 may be substantially ignored in some examples. This is because, for the shortest weld pair separation distances 814 (or, in examples where the linear distances are not the same for all weld pairs, the paths between weld pairs of least electrical resistance) have the lowest resistance between weld points of a weld pair. The parallel addition of resistances means that next-nearest busbar weld—terminal weld paths 816 may have a small (in some cases, negligible) effect on the total current flow from the terminal weld and connected electrical cell.

However, in some examples, the next nearest busbar welds 812 may also be accounted for along with the nearest busbar welds 810 to a terminal weld 812 in determining the electrical equivalence of current flow paths in the busbar assembly 806. That is, a first distance, which is considered in obtaining an equivalent current flow from each electrical cell in the cell array 1000 to the connecting busbar assembly 806 may comprise a plurality of electrically parallel distances 814, 816 between a terminal weld 812 and a plurality of nearest neighbouring busbar welds 810. Again, the aim is to design the positioning of terminal welds 812 and busbar welds 810 which provides an electrically equivalent path from each electrical cell in the array 1000 to the busbar assembly 806 so that each electrical cell is used equivalently in the cell array 1000.

Welding the terminal collection plate 804 to the lattice portion 802 at a plurality of busbar welds 810 may comprise controlling the laser welding system to control a laser beam generated by the laser welding system to produce a plurality of weld spots of a substantially circular spot shape to form the plurality of busbar welds 810. This can be seen in FIGS. 8a-8b where the busbar welds 810 have a circular shape. Discrete circular welds may be advantageous (rather than, for example, straight line welds) because circular spots allow for more precise path lengths to be easily designed. Furthermore, circular spot welds act to, desirably, distribute heat input across the busbar assembly 806 during welding, which straight line welds may be less effective at. Also, a circular busbar weld 810 provides a high strength weld to hold the lattice portion 802 and terminal collection plate 804 together compared to other shaped welds (e.g. a straight line weld) and provides a high strength to weld size ratio compared to other weld shapes.

Welding the plurality of terminal connection tabs 808 to respective electrical terminals of the plurality of electrical cells may comprise controlling the laser welding system to control a laser beam generated by the laser welding system to produce a weld path comprising a predetermined shape. The laser welding system may be configured to control the beam to oscillate elliptically about the weld path. The predetermined shape may be a continuous loop. For example, the continuous loop may comprise a disco-rectangle shape (i.e. a “racetrack” or “stadium” shape) or may be a circular weld shape. Such a shape may provide for good electrical and mechanical contact between the terminal and terminal connection tab 308 and be readily repeatable by the laser welding system across plural terminal welds.

In some examples the plurality of electrical cells of a battery module may each have a first end surface 1012, wherein a first electrical terminal of each cell is located in a central region of the first end surface 1012. The plurality of terminal connection tabs 808 may be protruding from the lattice portion 802 of the busbar assembly 806 and may each be welded to the central region of the first end surface 1012 of respective electrical cells of the plurality of electrical cells. In some examples the plurality of electrical cells of a battery module may each have at least part of a second terminal located in a peripheral region 1016 of the first end surface 1012. A second plurality of terminal connection tabs 808 may be protruding from a further lattice portion 802 of the busbar assembly 806 and may each be welded to the peripheral region 1016 of the first end surface 1012 of respective electrical cells of the plurality of electrical cells 1010.

Any of the abovementioned example busbar assemblies 806 may be part of a battery module 300, and a plurality of battery modules 300 as disclosed herein may be incorporated together to form a battery pack. It may be useful to be able to combine plural battery modules 300 together to form a larger battery pack and the busbar assemblies 206 may be designed to easily work together as a composite busbar assembly over all the cells of the battery pack. In some examples there may be one busbar assembly attached across plural electrical cell arrays.

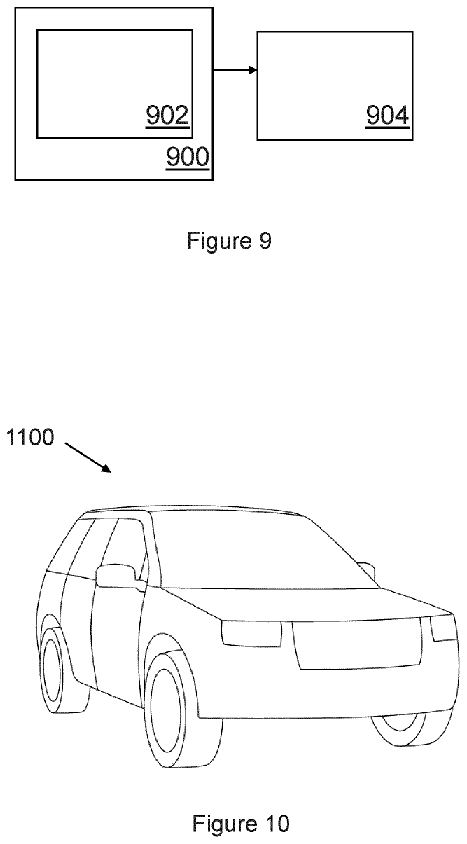

FIG. 9 shows a control system 900. The control system 900 may comprise one or more controllers 902. The control system 900 is configured to control a welding system 904 to perform a welding process to manufacture a battery module comprising a plurality of electrical cells and a busbar assembly as disclosed herein. Namely, the busbar assembly comprises a terminal collection plate and a lattice portion, and the lattice portion comprises a plurality of terminal connection tabs, and the control system 900 controls the welding system 904 to: weld the terminal collection plate to a lattice portion at a plurality of busbar welds to form the busbar assembly; and weld the plurality of terminal connection tabs to respective electrical terminals of the plurality of electrical cells, wherein each terminal connection tab is welded to its respective electrical terminal by a terminal weld, wherein a first distance is a distance along an electrical path on the lattice portion between one of the plurality of terminal welds and the closest of one of the plurality of busbar welds, and wherein the first distance for each terminal weld is substantially electrically equivalent.

The controller(s) 902 may each comprise a control unit or computational device having one or more electronic processors. A single control system 900 or electronic controller 900 may be used, or alternatively, different functions of the control system 902 may be embodied in, or hosted in, different controllers 902. A set of computer-readable instructions may be provided which, when executed, cause said controller(s) 902 or control module 900 to implement the methods described herein.

The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, or, optionally, on the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

FIG. 10 shows an example vehicle 1100, comprising any battery module 300 as disclosed herein, or any battery pack as disclosed herein.

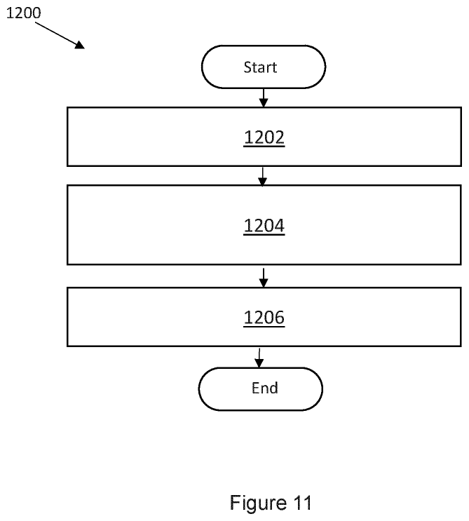

FIG. 11 shows a method 1200 for making a busbar assembly. The method starts with step 1202, in which a collection plate and a lattice portion are provided. The lattice portion comprises copper coated with a metallic layer to prevent oxidisation, which may comprise nickel and/or titanium.

The method then proceeds to step 1204, in which the lattice portion is positioned in contact with the collection plate. The method then proceeds to step 1206, in which the lattice portion is welded to the collection plate using a laser welding system.

Also encompassed in this disclosure is computer software (as an example of computer program code) that, when executed, is arranged to perform any method described herein, for example to control a laser welding system. The computer software may be stored in a micro-controller, firmware, and/or on a computer readable medium, and be therefore recorded on a non-transitory computer readable medium. That is, the computer software may be tangibly stored on a computer readable medium. It will be appreciated that examples of such computer program code may be realised in the form of hardware, software or a combination of hardware and software.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The claims are not restricted to the details of any foregoing examples. The claims cover and encompass any novel one, or any novel combination, of the features disclosed in this specification (including any accompanying claims, abstract and drawings), or to any novel one, or any novel combination, of the steps of any method or process so disclosed. The claims should not be construed to cover merely the foregoing examples, but also any examples which fall within the scope of the claims.

1. A busbar assembly comprising a terminal collection plate and a lattice portion electrically connected to the terminal collection plate,
wherein the lattice portion comprises a plurality of tabs arranged to protrude from the terminal collection plate, each tab being connectable to a terminal of an electrical cell, wherein the lattice portion comprises copper plated with a metallic layer for preventing oxidisation, wherein the metallic layer for preventing oxidisation comprises nickel and/or titanium.

2. A busbar assembly as claimed in claim 1, wherein the lattice portion is welded to the terminal collection plate.

3. A busbar assembly as claimed in claim 1, wherein at least part of the terminal collection plate extends in a first plane and the plurality of tabs are arranged to depend from the terminal collection plate at least partly in a direction normal to the first plane.

4. A busbar assembly as claimed in claim 3, wherein the lattice portion is laser welded to the terminal collection plate.

5. A busbar assembly as claimed in claim 1, wherein the lattice portion has a thickness of 0.2-0.4 mm preferably 0.3 mm.

6. A busbar assembly as claimed in claim 1, wherein the metallic layer to prevent oxidisation has a thickness of 0.5-5 microns.

7. A method of manufacture of the busbar assembly of claim 1, the method comprising:
providing a terminal collection plate and a lattice portion, wherein the lattice portion comprises copper plated with nickel and/or titanium;
positioning the lattice portion in contact with the terminal collection plate; and
welding the lattice portion to the terminal collection plate using a laser welding system.

8. A battery module comprising a busbar assembly as claimed in claim 1.

9. A battery pack comprising a plurality of busbar assemblies as claimed in claim 1.

10. A vehicle comprising a plurality of busbar assemblies as claimed in claim 1.

11. A battery pack comprising a plurality of battery modules as claimed in claim 8.

12. A vehicle comprising a battery module as claimed in claim 8.

13. A vehicle comprising a battery pack as claimed in claim 9.

14. A vehicle comprising a battery pack as claimed in claim 11.
